(19) United States
(12) Patent Application Publication
(10) Pub. No.: US 2025/0206892 A1
(43) Pub. Date: Jun. 26, 2025

(54) Lignin nanoparticle stabilized composite material

(71) Applicant: Aalto University Foundation sr, Aalto (FI)

(72) Inventors: Muhammad Farooq, Aalto (FI); Kimiaei Erfan, Aalto (FI); Monika Österberg, Aalto (FI)

(21) Appl. No.: 18/849,561

(22) PCT Filed: Mar. 21, 2023
(86) PCT No.: PCT/FI2023/050162

§ 371 Date: Sep. 23, 2024

(30) Foreign Application Priority Data
Mar. 21, 2022 (FI) 20227040

(51) Int. Cl. C08H 8/00; C08K 7/02

(52) U.S. Cl. CPC C08H 8/00; C08K 7/02

(57) ABSTRACT

According to an example aspect of the present invention, there is provided a novel composite material comprising a cellulosic material, a non-polar polymer and colloidal lignin nanoparticles enabling compatibility of said cellulosic materials and polymer. There is also provided a method for forming such composite material. The invention can be used in various applications utilizing biodegradable and waterproof composite materials.

### FIELD OF INVENTION

The present invention relates to a composite material comprising the combination of a cellulosic material, a non-polar polymer and colloidal lignin particles, and a film thereof. In particular, the invention relates to such composite material in which the colloidal lignin nanoparticles enable compatibility of said cellulosic material and polymer. Further, the present invention concerns a method of forming such composite material.

The invention disclosed herein also relates to the use of the composite material and the film in multiple applications, especially in manufacture of packaging materials.

### BACKGROUND

Nowadays, global warming concerns are highlighted as a major threat over other challenges in many societies. By increasing awareness toward sustainability, tremendous effort has been made to utilize the renewable resources of materials. Renewable materials such as bio-based polymers, natural fibers, and biomasses are practical candidates to alleviate the dependencies on non-sustainable fossil resources and petroleum-based plastics. The forest sector is key to building a future that fulfills the sustainable development goals (SDGs). Cellulosic fibers are prominent natural and biodegradable contenders to replace fossil-based plastics for high-performance applications.

However, there are still various challenges in the efficient use of cellulosic materials. Firstly, combining cellulose with many biopolymers to design composite with competitive properties to the fossil-based materials remains an obstacle due to their polar/non-polar interface. Secondly, the moisture sensitivity of cellulose has hampered its widespread commercialization. Several strategies, mostly based on surface modification of cellulosic fibers and their crosslinking with other materials, are employed to overcome the above-mentioned obstacles. The drawbacks of these approaches, in turn, are that they use toxic solvents or reagents, chemical cross-linking and/or fossil additives that significantly hinder biodegradability after use.

Surface modification of cellulose is described for example in publication CN 106009571 B, describing a preparation method of a composite made from cellulose nanocrystals (CNC) and polycaprolactone (PCL) through acetylation of CNC. Document US 20110201755 A1, in turn, discloses an approach for developing hydrophobic nanocomposite based on CNC through graft polymerization with hydrophobic vinyl monomer. Water-resistant materials based on ground cellulosic material containing an organic binder and an organosilicon or fluorinated acrylic copolymer hydrophobic agent is described in EP 0664357 A1.

Publication US20210155775A1 discloses use of maleated polymers as compatibilizers in a composite comprising polyethylene and nanocellulose.

Since all these methods use either chemical modification of cellulose or addition of fossil-based polymers, they increase the environmental impact of the material production process and hamper the natural biodegradability of cellulose, which is the primary motivating factor for using cellulosic materials at first place. Furthermore, these cellulose modifications may curtail the interconnected network of cellulose, which also weakens the mechanical robustness of cellulose. To uplift the cellulose status as an ultimate material platform for bioproduct design, the critical challenges associated with water interaction and cellulose dispersion in hydrophobic media need to be addressed in a sustainable and scalable manner. Thus, more development is needed to combine sustainable processes and biodegradability with properties competitive with traditional plastics.

### SUMMARY OF THE INVENTION

The present invention aims at solving at least some of the problems of the prior art. In particular, the present invention provides a sustainable and cost-effective alternative for the prior art solutions.

It is an object of the present invention to provide a biobased, biodegradable and waterproof composite material based on a combination of a cellulosic material, a non-polar polymer and colloidal lignin nanoparticles.

Thus, according to the first aspect the present invention relates to a composite material comprising a cellulosic material, a non-polar polymer and colloidal lignin nanoparticles. In particular, the invention relates to such composite material in which the colloidal lignin nanoparticles act as an interfacial mediator between the cellulosic material and the polymer.

According to the second aspect, the present invention relates to a film formed from the above-described composite material.

According to the third aspect, the present invention relates to a method for forming the above-described composite materials, and the film thereof.

According to the fourth aspect, the present invention relates to a use of the above-described composite material and film.

According to the fifth aspect, the present invention relates to a use of colloidal lignin nanoparticles as a compatibilizer in a composite material comprising a cellulosic material and at least essentially non-polar polymer.

Thus, the present invention is at least partially based on the idea of combining a cellulosic material and a polymer into a homogeneous composite material by using lignin nanoparticles as an interfacial mediator and/or stabilizer, i.e. as a compatibilizer, between the cellulosic material and the non-polar polymer, the colloidal lignin nanoparticles enabling good compatibility between said components, despite their initial incompatibility. Without colloidal lignin nanoparticles there is poor compatibility between non-polar polymers and cellulosic material, leading to poor mechanical properties. The method of the present invention utilizes excellent emulsion stabilization tendency of colloidal lignin nanoparticles and the hydrogen bonding ability of the phenolic groups on the surface of the lignin nanoparticles. Lignin nanoparticles have favorable interaction with cellulose, and the phenolic groups of lignin are especially suitable for bonding with non-polar polymers, especially with carbonyl groups of nonpolar polymers.

In particular, the present invention utilizes a so-called Pickering emulsion approach in which lignin nanoparticles are used as an emulsion stabilizer, i.e. compatibilizer, to provide a stable polymer emulsion, especially a Pickering emulsion, with small and uniform polymer droplet size. Such stabilized polymer emulsion can be further dispersed, preferably evenly dispersed, in a matrix formed by a cellulosic material to further stabilize the emulsion. Thus, a stable composite material is obtained. Thus, the present invention introduces a novel Pickering emulsion approach to prepare multifunctional composite materials, especially bio-composite materials, that enable combining polar cellulose components, such as cellulose fibers, with non-polar polymers by using lignin nanoparticles as an emulsion stabilizer and/or interfacial mediator. The method provides a sustainable route to form cellulosic material-reinforced polymer composites by engineering the cellulosic material and polymer interface by using colloidal lignin nanoparticles.

The composite material of the present invention can be in the form of an emulsion, especially a Pickering emulsion/Pickering emulsion template, or it can be dried.

Thus, it has been surprisingly found in the present invention that compatibility of a polar cellulosic material and a non-polar polymer can be enhanced with colloidal lignin nanoparticles, thereby forming an improved composite material. Thereby, the invention enables combining cellulosic material with non-polar biodegradable polymers with the aid of lignin nanoparticles (LNPs) as the interfacial mediator between the cellulose and the non-polar polymer, retaining the excellent features of both the cellulosic material (e.g., high strength and modulus) and the biodegradable non-polar polymer (e.g., flexibility and hydrophobicity) at the same time.

In particular, the present invention is characterized by what is stated in the independent claims. Some specific embodiments are defined in the dependent claims.

Several advantages are reached using the present invention. Among others, the present invention provides a bio-based and biodegradable composite material. In addition to using bio-based polymers, the lack of covalent bonding between the components and lack of chemical modification makes the biodegradability of the material after use even easier. Thus, the approach retains the biodegradability of the composite, in contrast to chemical modification or crosslinking, which hinders the biodegradability of typical composite films.

Further, the composite material provides water-resistance combined with excellent mechanical properties in both dry and wet conditions. The three-component system of the composite material possesses competitive strength and flexibility to traditional plastics and other biomaterials, the composite material also having high wet strength, solving the problem regarding compromising the mechanical properties in wet and humid conditions, commonly present with cellulosic materials.

In particular, the invention lies in replacing synthetic non-degradable polymers and composites thereof with an eco-friendly combination of biodegradable polymers and cellulose component with the aid of colloidal lignin nanoparticles as a compatibilizer, thereby exhibiting end-of-life biodegradability and compostability for various demanding applications, such as packaging. The invention address the current challenges that have hampered the efficient use of cellulose and lignin in composites, including poor compatibility between hydrophilic reinforcement fibers and hydrophobic polymer matrix, moisture sensitivity, and low flexibility of the materials. Thereby, the invention paves the path toward developing a new generation of bio-composites engineered by wood-based building blocks.

In addition, the composite material of the present invention shows excellent barrier properties, especially against moisture, oxygen, UV light, and oxidation critical parameters, whereas some other alternative bio-based materials may not meet these requirements simultaneously. Thus, the present composite material can be used to prolong the self-life of containers, for example. The composite material of the present invention, even as a thin film, can prevent or at least slow down the moisture penetration through the material also in environments with high moisture content.

Thus, the present invention provides a multifunctional bio-based, biodegradable and waterproof cellulosic value-added material.

Further, the method of the present invention provides an environmentally friendly and cost-effective manner to produce such multifunctional composite materials. The invention accomplishes significant cost-effectiveness based on the low manufacturing costs of the raw materials and avoiding any complicated treatments. In terms of sustainability, replacing non-degradable plastics with biodegradable and renewable materials reduces microplastic pollution and resource scarcity problems.

Next, embodiments will be examined more closely with the aid of a detailed description with reference to the appended drawings.

### BRIEF DESCRIPTION OF THE DRAWINGS

FIG. 1 illustrates the structure of the composite material according to one embodiment of the present invention, the composite material comprising 70 wt. % CNF and 30 wt. % PCL+CLP;

FIG. 1a showing a Schematic presentation of the arrangement of the components of the composite material according to one embodiment of the present invention,

FIG. 1b showing a top-view scanning electron microscopy (SEM) image of the composite material according to one embodiment of the present invention,

FIG. 1c showing a top-view SEM image of an ambient dried film formed from the composite material according to one embodiment of the present invention, and

FIG. 1d showing a top-view SEM image of a hot-press dried film formed from the composite material according to one embodiment of the present invention.

FIG. 2 shows the stress-strain curves of a dry tensile test of neat films formed from the composite material according to one embodiment of the present invention containing 90 wt. % CNF and 10 wt. % PCL+CLP. FIG. 2a showing the curves of an ambient dried film and FIG. 2b a hot-press dried film.

FIG. 3 shows the stress-strain curves of a wet tensile test of neat hot-press dried films formed form the composite material according to one embodiment of the present invention containing 70 wt. % CNF and 30 wt. % PCL+CLP.

In addition, FIG. 3 shows a photo of a water droplet on the surface of the composite material after 60 seconds.

FIG. 4 shows the measured UV-shielding properties of a film formed from the composite materials according to one embodiment of the present invention containing 70 wt. % CNF and 30 wt. % PCL+CLP.

FIG. 5 shows the measured antioxidant properties of a film formed from the composite materials according to one embodiment of the present invention containing 70 wt. % CNF and 30 wt. % PCL+CLP.

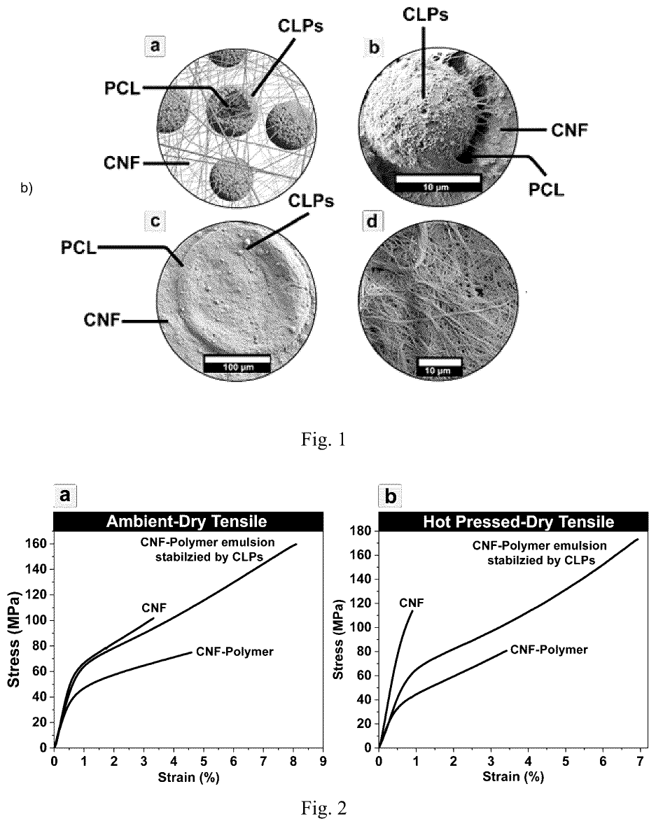

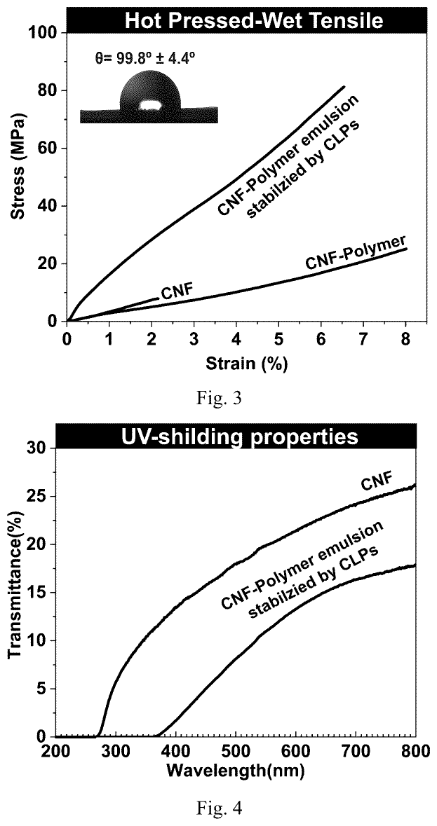

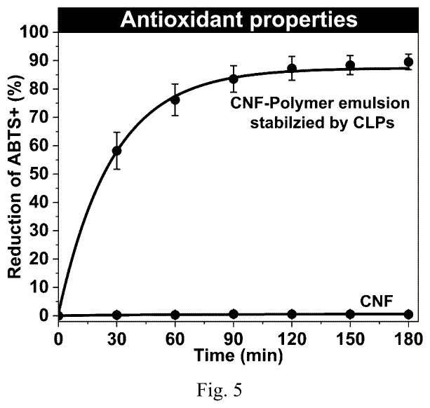

### DETAILED DESCRIPTION OF EMBODIMENTS

Unless otherwise stated, properties that have been experimentally measured or determined herein have been measured or determined at room temperature. Unless otherwise indicated, room temperature is 25° C.

Unless otherwise stated, properties that have been experimentally measured or determined herein have been measured or determined at atmospheric pressure.

It must also be noted that, as used in the specification and the appended claims, the singular forms “a,” “an” and “the” include plural referents unless otherwise specified.

As used herein, the term “average particle size” refers to the number average particle size based on a largest linear dimension of the particles (also referred to as “diameter”) as determined using a technique known to those skilled in the art such as Light Scattering technique.

As used herein, the term “average particle size” refers to the D₅₀ value of the cumulative volume distribution curve at which 50% by volume of the particles have a diameter less than that value.

The present invention concerns a composite material comprising a cellulosic material, a non-polar polymer and colloidal lignin nanoparticles enabling compatibility of said cellulosic material and polymer.

Thus, the present invention also concerns use of colloidal lignin nanoparticles as a compatibilizer in a composite material comprising a cellulosic material and at least essentially, preferably fully, non-polar polymer.

According to a preferred embodiment, the composite materials is fully biobased and biodegradable. In one embodiment, the composite material is at least 60, 65, 70, 75, 80, 85, 90, 95 or 99 wt. % biobased, preferably 100 wt. % biobased, calculated from the total weight of the composite material.

Cellulosic materials are polar materials that are not as such compatible with non-polar components, such as non-polar polymers. Thus, according to a preferred embodiment, the colloidal lignin nanoparticles act as an interfacial mediator between the cellulosic material and the polymer in the composite material of the present invention. Thereby, the colloidal lignin particles are preferably located in the interface of the cellulosic material and the polymer, enabling a stable composite material. Thus, the colloidal lignin particles act in the composite material as an emulsion stabilizer and/or interfacial mediator, i.e., as a compatibilizer.

Herein, the term colloidal lignin nanoparticle (CLP; plural, CLPs) refers to lignin material that does not sediment in a fluid upon holding still for at least two hours. Moreover, CLPs can be passed through a filter membrane with a particle retention value of less than 15 micrometers, preferably less than 2 micrometers, in particular less than 1 micrometer.

According to a preferred embodiment, the colloidal lignin particles have an average particle size in the range of 50 to 1000 nm, preferably in the range of 50 to 200 nm, for example in the range of 50 to 100 nm, measured by dynamic light scattering.

In one preferred embodiment, the colloidal lignin nanoparticles are spherical. According to one embodiment, spherical particle refers to a particle that exhibit a rotational symmetrical shape akin to that of spheres, i.e. spherical particle has a form like a sphere in being round, or more or less round, in three dimensions. The spherical colloidal lignin nanoparticles are preferably internally homogeneous and fully cross-linked.

According to one embodiment, the composite material comprises 0.5 to 15 wt. %, preferably 1 to 10 wt. %, such as 2 to 8 wt. %, colloidal lignin nanoparticles, calculated from the solid weight of the composite material.

According to one embodiment, the composite material comprises 0.5 to 15 wt. %, preferably 1 to 10 wt. %, such as 2 to 8 wt. %, colloidal lignin nanoparticles, calculated from the total weight of the composite material.

The lignin of the colloidal lignin particles can be any type of lignin, such as softwood kraft lignin, hardwood kraft lignin, residual lignin from bioethanol production using various strategies, organosolv lignin, with the exception of lignin that is water soluble at neutral pH. The biological source of lignin may be wood, annual plants, agricultural waste, saw dust etc, basically any vascular plant containing lignin.

The cellulosic material of the present invention can be any cellulosic materials. In a preferred embodiment, the cellulosic material is selected from the group of cellulose fibers, cellulose fibrils, cellulose nanofibers, cellulose nanofibrils, microcrystalline cellulose and cellulose nanocrystals, and a mixture thereof.

According a preferred embodiment, the cellulosic material is cellulose nanofibrils (CNF). Cellulose nanofibrils refers to cellulose fibrils obtained from mechanical disintegration of cellulosic fibers (abundant in wood and agricultural residue). Such cellulose nanofibrils typically have a width of 5 to 100 nm, preferably 5 to 40 nm, for example 5 to 20 nm, measured by surface-sensitive microscopes, such as atomic force microscope (AFM)

The aim of the present invention is to provide a fully bio-based and biodegradable composite material. Thus, according to a preferred embodiment, the cellulosic material is used in its natural biodegradable form, instead of using chemical modification or cross-linking with fossil-based polymers.

The polymer of the present invention can be any non-polar polymer that cannot be dissolved in water. In general, non-polar polymer is a molecule that has no separation of charge, so no positive or negative poles are formed. In other words, the electrical charges of non-polar molecules are evenly distributed across the molecule. Further, the polymer is preferably also biodegradable.

According to one embodiment, the polymer is polyester, preferably selected from the group of polycaprolactone (PCL), polylactic acid (PLA), polybutylene succinate, polybutylene succinate adipate, polyhydroxy alkanoate, polyhydroxy butyrate and combinations thereof.

In a preferred embodiment, the polymer is polycaprolactone (PCL) that is a synthetic and biodegradable polymer.

In another embodiment, the polymer is polylactic acid (PLA) that is a synthetic polymer derived from organic sources, such as corn starch and sugar cane.

Thus, according to one embodiment, the composite material comprises the combination of a polar cellulosic material and non-polar polymer with the help of colloidal lignin nanoparticles. In one particular embodiment, the composite material comprises the combination of cellulose nanofibrils, polycaprolactone and colloidal lignin nanoparticles.

According to one embodiment, the composite material may further comprise additives and adjuvants, such as salts, pH regulating compounds, including organic and inorganic, ionic, and non-ionic compounds, and combinations thereof. Typically, the amount of such compounds is 0.01 to 10%, in particular 0.1 to 5%, by weight of the total composite material.

As being described above, the present invention is based on a three-component system, where a non-polar polymer solution is dispersed in an aqueous cellulosic media with the help of lignin nanoparticles thereby forming a stable oil in water emulsion, i.e. Pickering emulsion or Pickering emulsion template, from polymer droplets evenly dispersed in cellulose. Thus, the emulsion comprises a cellulosic matrix having polymer droplets surrounded by colloidal lignin particles dispersed therein. In one embodiment, this three-component emulsion comprising a cellulosic material, a non-polar polymer and colloidal lignin nanoparticles is dried, especially dried to form a film. As shown in FIG. 1, the components of the composite material are evenly distributed without any voids or phase separation.

According to one embodiment, the composite material is formed by dispersing a polymer emulsion comprising the non-polar polymer and the colloidal lignin nanoparticles in a matrix formed by the cellulosic material.

Thus, the composite material of the present invention can be in the form of an emulsion, or it can be dried into a solid form, such as into a film.

Thus, the present invention also concerns a three-component emulsion comprising the composite material according to any embodiment of the present invention, in an aqueous medium. In particular, the emulsion is an intermediate product of the film formed from the composite material, i.e. the solid composite material is obtained from the three-component emulsion. The three-component emulsion is a so-called Pickering emulsion, and is herein also called a Pickering emulsion template since it can act as a template for the solid composite material, and especially for a composite film, or any other application.

According to one embodiment, the solid composite material is obtained by drying the emulsion, especially the Pickering emulsion template, preferably into a water content of less than 20 wt. %, more preferably less than 10 wt. %, most preferably less than 5 wt. %, such as less than 1 wt. %, calculated from the total weight of the composite material.

Thus, according to one embodiment, the solid composite material has a solid content of at least 80 wt. %, more preferably at least 90 wt. %, most preferably at least 95 wt. %, such as at least 99 wt. %, calculated from the total weight of the composite material.

According to one embodiment, all the three components of the composite material are in form of an aqueous dispersion. Thus, in one embodiment the composite material in the form of an emulsion comprises an aqueous phase containing cellulose and droplets of the non-polar polymer stabilized by the lignin particles. Further, the non-polar polymer part may comprise the polymer dissolved in an organic solvent, such as toluene. The composite material in the form of a emulsion preferably has a water content of at least 20, 25, 30, 35, 40, 45, 50, 55, 60, 65, 70, 75, 80 wt. %, calculated from the total weight of the emulsion. In one embodiment, the composite material in the form of an emulsion has a water content of 20 to 80 wt. %, such as 40 to 60 wt. %, calculated from the total weight of the emulsion.

In another embodiment, the composite material is dried into a solid form, being at least essentially free of water. Preferably, the composite material then has a water content of less than 20 wt. %, more preferably less than 15 wt. %, such as less than 10, 5 or 1 wt. %, calculated from the total weight of the composite material.

The film of the present invention preferably has a water content of less than 1 wt. %, more preferably less than 0.5 wt. %, calculated from the total weight of the film.

According to one embodiment, the amount of the cellulosic material is 60 to 95 wt. %, preferably 70 to 90 wt. %, for example 80 wt. %, calculated from the solid matter content of the composite material.

According to one embodiment, the amount of the cellulosic material is 60 to 95 wt. %, preferably 70 to 90 wt. %, for example 80 wt. %, calculated from the total weight of the composite material.

According to one embodiment, the amount of the non-polar polymer is 5 to 40 wt. %, preferably 10 to 30 wt. %, for example 20 wt. %, calculated from the solid matter content of the composite material.

According to one embodiment, the amount of the non-polar polymer is 5 to 40 wt. %, preferably 10 to 30 wt. %, for example 20 wt. %, calculated from the total weight of the composite material.

According to one embodiment, the amount of the colloidal lignin particles is 0.5 to 15 wt. %, preferably 1 to 10 wt. %, such as 2 to 8 wt. %, for example 5 wt. %, calculated from the solid matter content of the composite material.

The present invention also concerns a film formed from the composite material of the present invention. Thus, the film is formed from the composite material characterized by all the embodiments described above. The film of the present invention can be a free-standing film or it can be used as a coating layer on a substrate. Both thin and thick films are suitable to be made from the composite material of the present invention.

According to one embodiment, the film has a thickness of 80 to 150, preferably 100 to 120 micrometers.

Further, the present invention relates to use of such composite material and the film thereof. The material and the film of the present invention are especially suitable to be used in packaging or single-used plastic applications. In a preferred embodiment, the composite material is used in form of a free-standing film or as a coating layer for substrates, especially for porous substrates, such as fiber-based porous substrates. The material in emulsion form can be used in cosmetics or biomedical applications to incorporate hydrophobic components like drugs or active compounds in the emulsion.

The present invention also concerns a method of forming a composite material, especially the composite material of the present invention, i.e. the composite material formed by the method is characterized by all the above-described embodiments.

Thus, in one embodiment, the present invention concerns a method for forming a composite material comprising a cellulosic material, a non-polar polymer and colloidal lignin nanoparticles enabling compatibility of said cellulosic materials and polymer.

The method of the present invention utilizes a so-called Pickering emulsion approach. Such method enables dispersing a non-polar polymer into a polar matrix of a cellulosic material.

According to one embodiment, a polymer solution, especially a non-polar polymer solution, is first provided, i.e. the polymer is dissolved in a suitable solvent to form a polymer solution. In one embodiment, the polymer solution is provided by dissolving the polymer in an organic solvent, such as toluene or acetone. In one embodiment the polymer is dissolved in toluene. However, any suitable solvent for dissolving non-polar polymers can be used.

Water is preferably further added into the polymer solution, or the polymer solution is added into water, i.e. the polymer solution is dispersed in water. Thus, there is provided an aqueous dispersion of polymer solution droplets in water, i.e. a polymer solution.

According to further embodiment, the polymer solution is mixed with colloidal lignin nanoparticles in order to stabilize the solution, thus forming a Pickering emulsion. Thus, the colloidal lignin nanoparticles act as an emulsion stabilizer. Generally, Pickering emulsion is an emulsion that is stabilized by solid particles which absorb onto the interface between two liquid phases. In the present invention, colloidal lignin particles as solid particles absorb onto the interface of the polymer solution droplets and water, enabling formation of small polymer solution droplets.

Next, the obtained Pickering emulsion is mixed with the cellulosic material, preferably with a dispersion of the cellulosic material, especially an aqueous dispersion. Thus, the non-polar polymer droplets surrounded by the colloidal lignin nanoparticles disperse in the cellulosic material since the colloidal lignin nanoparticles have suitable interaction with cellulosic materials. A further stabilized Pickering emulsion or Pickering emulsion template is obtained.

Terms “Pickering emulsion” and “Pickering emulsion template” can be used to refer to same emulsion, term “Pickering emulsion template” optionally being used for the final obtained emulsion, such emulsion being suitable to be used as a template for solid composite material.

In one embodiment, the cellulosic material is provided as an aqueous dispersion, preferably diluted to a solid content of 0.5 to 5, such as 1 to 2 wt. %, calculated from the total weight of the aqueous dispersion of the cellulosic material.

According to one embodiment, the obtained emulsion, i.e Pickering emulsion template, is homogenized, wherein a composite a homogeneous composite material, is obtained.

According to one embodiment, the obtained emulsion, i.e Pickering emulsion template, is further subjected to filtration, especially pressurized filtration, for example at a pressure of 1-2 bar.

According to one embodiment, the optionally filtrated emulsion, i.e Pickering emulsion template, is formed into a film, especially a free-standing film.

According to one embodiment, the emulsion or the film thereof is dried. The emulsion or the film can be subjected to ambient drying or a separate drying step by any conventional drying method can be performed. The emulsion or the film is preferably dried to a water content of less than 1% wt. %, calculated from the total weight of the emulsion mixture or film.

According to one embodiment, the emulsion or the film, especially the film, is subjected to pressing, preferably hot-pressing. Pressing can also be used to dry the emulsion of the film thereof. In a preferred embodiment, a hot-press machine is used, especially at a temperature in the range of 70 to 180° C.

Thus, the method of the present invention comprises the steps of
providing a non-polar polymer solution,
mixing the non-polar polymer solution with colloidal lignin nanoparticles to provide a Pickering emulsion,
mixing the Pickering emulsion with a cellulosic material.

According to one embodiment, a Pickering emulsion template is provided.

In a preferred embodiment, the Pickering emulsion is mixed with a cellulosic material to further increase the emulsion stability.

According to one embodiment, the obtained emulsion, i.e. the Pickering emulsion template, is dried, wherein a solid composite material is preferably obtained.

Numerous other variations and modifications in the invention as illustrated in the specific examples will be apparent to those skilled in the art, and hence it is not intended that the invention be limited to the examples but only as required by the spirit and scope of the appended claims.

### EXAMPLES

### Example 1

10 g polycaprolactone was dissolved in 100 g toluene to form a polymer solution as the oil phase. An aqueous dispersion of the polymer solution droplets was prepared by adding water. Next, colloidal lignin nanoparticles were added to form a stabilized Pickering emulsion. The volume fraction of the oil and water phase and the ratio between polycaprolactone and colloidal lignin nanoparticles were constant at 0.5 and 5:1, respectively.

Such emulsion was combined with cellulose nanofibrils, and the mixture was homogenized. The homogenized mixture was transferred into a pressurized filtration and formed into a film.

The obtained wet film was initially ambiently dried and then subjected to hot pressing at a temperature of 75° C.

### INDUSTRIAL APPLICABILITY

The present technology can be applied to produce biodegradable multifunctional composite materials, and especially waterproof films thereof.

The composite material of the present invention can be generally used in replacement of any conventional composite materials in various applications, such coatings, binders, cosmetics, Pickering emulsions, antibacterial formulations, flocculants, drug delivery and food processing. In particular, the composite material of the present invention is suitable to be used in packaging applications.

### CITATION LIST

### Patent Literature

CN 106009571 B

US 20110201755 A1

EP 0664357 A1

US20210155775A1

1. A composite material comprising a cellulosic material, a non-polar polymer, and colloidal lignin nanoparticles, wherein the colloidal lignin particles are effective in enabling compatibility of said cellulosic material and said non-polar polymer.

2. The composite material according to claim 1, wherein the colloidal lignin nanoparticles act as an interfacial mediator between the cellulosic material and the polymer.

3. The composite material according to claim 1, wherein the cellulosic material is selected from the group of cellulose fibers or fibrils, cellulose nanofibers or nanofibrils (CNF), microcrystalline cellulose or cellulose nanocrystals (CNC), or a mixture thereof.

4. The composite material according to claim 1, wherein the cellulosic material is cellulose nanofibrils having a width of 5 to 100 nm, more preferably 5 to 40 nm, such as 5 to 20 nm, measured by a surface sensitive microscope.

5. The composite material according to claim 1, wherein the cellulosic material is in its natural biodegradable form, instead of using chemical modification or cross-linking with fossil-based polymers.

6. The composite material according to any of the preceding claims, wherein the composite material comprises 60 to 95 wt. % of the cellulosic material, calculated from the solid weight of the composite material.

7. The composite material according to an claim 1, wherein the polymer is a biodegradable polymer.

8. The composite material according to claim 1, wherein the non-polar polymer is polyester, polycaprolactone (PCL), polylactic acid (PLA), polybutylene succinate, polybutylene succinate adipate, polyhydroxy alkanoate, polyhydroxy butyrate, or a combination thereof.

9. The composite material according to claim 1, wherein the composite material comprises 5 to 40 wt. %, of the non-polar polymer, calculated from the solid content of the composite material.

10. The composite material according to claim 1, wherein the colloidal lignin nanoparticles have an average particle size in the range of 50 to 1000 nm measured by dynamic light scattering.

11. The composite material according to claim 1, wherein the colloidal lignin nanoparticles are spherical colloidal lignin particles.

12. The composite material according to any of the preceding claims, wherein the composite material comprises 0.5 to 15 wt. % of the colloidal lignin particles, calculated from the solid content of the composite material.

13. The composite material according to claim 1, wherein the composite material is formed by dispersing a polymer emulsion comprising the non-polar polymer and the colloidal lignin nanoparticles in a matrix formed by the cellulosic material.

14. The composite material according to claim 1, wherein the composite material has a water content of less than 20 wt. %, calculated from the total weight of the composite material.

15. The composite material according to claim 1, wherein the composite material is in a form of a Pickering emulsion comprising a polymer emulsion comprising the non-polar polymer and the colloidal lignin nanoparticles, said polymer emulsion being dispersed in a matrix formed by the cellulosic material.

16. The composite material according to claim 15, wherein the Pickering emulsion comprises an aqueous medium and optionally an organic solvent, the Pickering emulsion having a water content of 20 to 80 wt. %, calculated from the total weight of the emulsion.

17. A film comprising the composite material according to claim 1.

18. A method for forming a composite material comprising the steps of:
providing a non-polar polymer solution,
mixing the non-polar polymer solution with colloidal lignin nanoparticles to provide a Pickering emulsion, and
mixing the Pickering emulsion with a cellulosic material to obtain a Pickering emulsion template.

19. The method according to claim 18, wherein the polymer solution is obtained by dissolving a non-polar polymer into an organic solvent.

20. (canceled)

21. The method according to claim 18, wherein the cellulosic material is provided as an aqueous dispersion, preferably diluted to a solid content of 0.5 to 5, calculated from the total weight of the aqueous dispersion of the cellulosic material.

22-26. (canceled)
